(19) United States
(12) Patent Application Publication
(10) Pub. No.: US 2024/0090093 A1
(43) Pub. Date: Mar. 14, 2024

(54) COOKING APPLIANCE

(71) Applicant: SAMSUNG ELECTRONICS CO., LTD., Suwon-si (KR)

(72) Inventors: Namsoo PARK, Suwon-si (KR); Hyungkwen HAM, Suwon-si (KR)

(73) Assignee: SAMSUNG ELECTRONICS CO., LTD., Suwon-si (KR)

(21) Appl. No.: 18/511,198

(22) Filed: Nov. 16, 2023

Related U.S. Application Data
(63) Continuation of application No. PCT/KR2022/005892, filed on Apr. 26, 2022.

(30) Foreign Application Priority Data
May 20, 2021 (KR) 10-2021-0064602

(51) Int. Cl. H05B 6/64; E05C 3/00; E05C 3/16

(52) U.S. Cl. CPC H05B 6/6414; E05C 3/004; E05C 3/167

(57) ABSTRACT

A cooking appliance including a door; a key member on the door; a main body; and a latch device on the main body. The latch device includes a first lever, and a second lever that, when the door is being closed, is pressed by the key member to thereby cause the second lever to rotate in a first direction so as to press the first lever and thereby cause the first lever to rotate in the first direction. A spring holding portion is on the first lever. A first end of a spring is attached to the first lever and slidably held by the spring holding portion. A second end of the spring is attached to the body. The spring provides an elastic force to cause the first lever to rotate in a second direction opposite to the first direction when the door is being opened.

### TECHNICAL FIELD

The disclosure relates to a cooking appliance with an improved door locking structure.

### BACKGROUND ART

In general, cooking appliances are appliances for cooking an object to be cooked, and include, for example, ovens.

An oven is an appliance for cooking food, including a cooking chamber, a heating device that applies heat to the cooking chamber, and a circulation device that circulates heat generated by the heating device within the cooking chamber. In addition, an oven is an appliance for cooking food to be cooked by enclosing and heating the food, and may be classified into electric, gas, and electronic types according to its heat source. An electric oven uses an electric heater as a heat source, while a gas oven and a microwave oven use the gas heat and the frictional heat of water molecules caused by high frequencies, respectively, as a heat source.

A microwave oven is a cooking appliance that heats food using the properties of electromagnetic waves, commonly known as microwaves. The microwave oven uses a dielectric heating method to heat food by generating heat from the inside of the food. High-frequency electromagnetic waves colliding with the food cause the water molecules in the food to rotate, disrupting the molecular arrangement of the food. The microwave oven uses the heat generated by the rotation of the water molecules to heat the food.

A microwave oven that is operated with a door open may leak microwaves that are harmful to the human body. Accordingly, the microwave oven needs to be operated with the door completely closed to avoid such leakage. To secure the door to a main body of the microwave oven, the microwave oven includes a key member provided on the door and a latch device provided on the main body to secure the door to the main body.

To completely close the door, a large latching force is required to secure the key member to the latch, but conversely a large force may be required to close the door.

### DISCLOSURE

### Technical Problem

The present disclosure is directed to providing a cooking appliance with an improved door locking structure to allow a door to be closed with a small force while maintaining a holding force when the door is closed.

### Technical Solution

According to an embodiment of the disclosure, a cooking appliance may include a door; a key member on the door; a main body; and a latch device on the main body and which becomes locked with the key member when the door is being closed. The latch device may include a body, a first lever rotatably coupled to the body, a second lever that, when the door is being closed, is pressed by the key member to thereby cause the second lever to rotate in a first direction so as to press the first lever and thereby cause the first lever to rotate in the first direction, a spring holding portion on the first lever, and a spring having a first end and a second end. The first end may be attached to the first lever and slidably held by the spring holding portion so as to be at a first position in the spring holding portion when the door is open and at a second position in the spring holding portion when the door is closed. The second end may be attached to the body. The spring may provide an elastic force to cause the first lever to rotate in a second direction opposite to the first direction when the door is being opened.

According to an embodiment of the disclosure, the spring may provide an elastic force to cause the first lever to rotate in a second direction opposite to the first direction when the door is being opened.

According to an embodiment of the disclosure, the spring holding portion is a slot.

According to an embodiment of the disclosure, the spring may be a torsion spring, and the second end of the spring may be held to the body so as to prevent movement of the second end of the spring.

According to an embodiment of the disclosure, the first end of the spring may be provided with a bush slidably inserted into the slot to allow the first end of the spring to slide along the slot.

According to an embodiment of the disclosure, the spring may provide an elastic force to cause the first lever to rotate in the first direction in response to the second lever being pressed by the key member when the door is being closed.

According to an embodiment of the disclosure, the first position may correspond to a first end of the slot that is widened to allow the first end of the spring to be at a maximum angle relative to the second end of the spring when the door is open.

According to an embodiment of the disclosure, the second position may correspond to a second end of the slot that is widened to allow the first end of the spring to be at a maximum angle relative to the second end of the spring when the door is closed.

According to an embodiment of the disclosure, the spring may be positioned at the first position to allow an elastic force for rotating the first lever in the second direction when the door is being opened to be small, so that the door may be closed with a small force.

According to an embodiment of the disclosure, the spring may be positioned at the second position to allow an elastic force for rotating the first lever in the first direction when the door is being closed to be small, so that a force for locking the door may increase.

According to an embodiment of the disclosure, the latch device may further include a stopper connected to the second lever and restricting rotation of the first lever, and a sensor selectively pressed by the first lever for detecting whether the door is open or closed.

According to an embodiment of the disclosure, the body may include an interference hole into which the stopper is inserted to restrict the rotation of the first lever, and the stopper may be separated from the interference hole in response to the second lever rotating in the first direction, so that the first lever rotates in the first direction together with the second lever.

According to an embodiment of the disclosure, the latch device may further include a first elastic member having a first end connected to the first lever and a second end connected to the second lever, and the first elastic member exerts an elastic force that causes the second lever to rotate in the second direction relative to the first lever.

According to an embodiment of the disclosure, the latch device may further include a pressing member rotatably provided on the body to be pressed by the first lever in response to the first lever rotating in the first direction, and the pressing member may be rotated to press a switch provided in the sensor when pressed by the first lever.

According to an embodiment of the disclosure, the latch device may further include an elastic member having a first end connected to the spring and a second end attached to the body, and the elastic member exerts an elastic force to the spring in a direction in which the key member is inserted into the latch device.

### Advantageous Effects

According to various embodiments of the disclosure, the door may be closed with a small force while maintaining the holding force of the door, thereby improving the emotional quality.

### DESCRIPTION OF DRAWINGS

FIG. 1 is a perspective view illustrating a cooking appliance according to an embodiment of the disclosure.

FIG. 2 is a side view illustrating the cooking appliance according to an embodiment of the disclosure.

FIG. 3 is an exploded perspective view illustrating a key member and a latch device as a mounting device according to an embodiment of the disclosure.

FIG. 4 is a view illustrating a state in which a spring is fastened to a first lever according to an embodiment of the disclosure.

FIG. 5 is a view illustrating a state in which a stopper is connected to a second lever according to an embodiment of the disclosure.

FIG. 6 is a view illustrating a state in which a guide protrusion of the second lever is inserted into a guide groove of the stopper and the stopper is moved as the second lever rotates according to an embodiment of the disclosure.

FIG. 7 is a view illustrating a state prior to the latch device being pressed by the key member according to an embodiment of the disclosure.

FIG. 8 is a view illustrating a state in which the key member contacts the latch device according to an embodiment of the disclosure.

FIG. 9 is a view illustrating a state in which the first lever and the second lever are rotated in a first direction when the latch device is pressed by the key member according to an embodiment of the disclosure.

FIG. 10 is a view illustrating a state in which a hook portion of the latch device is inserted into and locked to a locking hole of the key member according to an embodiment of the disclosure.

### MODES OF THE INVENTION

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “front”, “rear”, “top”, “bottom”, “upper”, and “lower” may be defined by the drawings, but the shape and the location of the component is not limited by the term.

Hereinafter, various embodiments according to the disclosure will be described in detail with reference to the accompanying drawings.

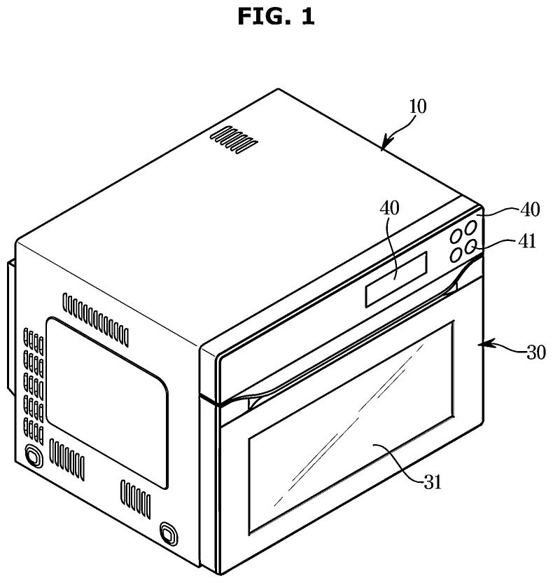

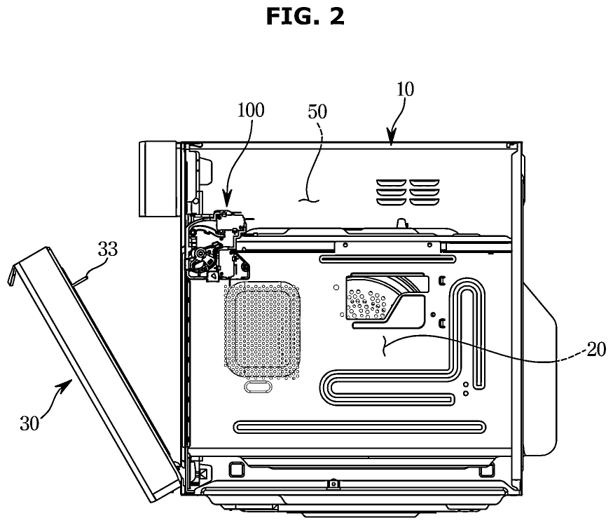

FIG. 1 is a perspective view illustrating a cooking appliance according to an embodiment of the disclosure. FIG. 2 is a side view illustrating the cooking appliance according to an embodiment of the disclosure.

Hereinafter, for ease of description, a direction in which a door 30 is installed relative to a main body 10 of a cooking appliance is defined as forward.

As shown in FIGS. 1 and 2, the cooking appliance may include the main body 10 forming an exterior. The cooking appliance may include a cooking chamber 20 in which a space for cooking food to be cooked is formed within the main body 10 and a front side thereof is open. The cooking appliance may include the door 30 provided on a front side of the main body 10 to open and close the cooking chamber 20.

The cooking chamber 20 may be provided within the main body 10. The cooking chamber 20 may be formed spaced apart inwardly of the main body 10 at predetermined intervals. The cooking chamber 20 may be provided to have the open front.

The cooking chamber 20 may be formed by combining a plurality of plates. According to one example, the cooking chamber 20 may include side plates forming side surfaces of the cooking chamber 20, an upper plate forming an upper surface of the cooking chamber 20, and a lower plate forming a lower surface of the cooking chamber 20. The side plates, the upper plate, and the lower plate may each be joined by welding. Alternatively, the side plates, the upper plate, and the lower plate may each be combined by bolting. In addition, the cooking chamber 20 may be formed by bending one plate.

The open front of the cooking chamber 20 may be open and closed by the door 30. The door 30 may be hinged to one side of a front surface of the main body 10 to open and close the cooking chamber 20.

The door 30 may include a viewing window 31 provided on the front surface to allow a user to see the inside of the cooking chamber 20 in a state in which the cooking chamber 20 is closed. The user may check a cooking process of the food being cooked in the cooking chamber 20 through the viewing window 31 of the door 30.

The door 30 may be opened and closed by being hinged with the main body 10. For example, a lower end of the door 30 and a lower front end of the main body 10 may be coupled with a hinge (not shown). The door 30 may include a key member 33 provided to protrude from a rear surface of the door 30 and to lock the door 30 to the main body 10.

The cooking appliance may include a locking device to allow the door 30 to be locked in a closed state. When the hinge is provided at each of lower ends of the door 30 and the main body 10, the locking device may be provided at the respective upper ends of the door 30 and the main body 10. The locking device may include the key member 33 provided to protrude from the rear surface of the door 30. The locking device may include a latch device 100 provided on the front surface of the main body 10 and restraining the key member 33. A detailed description of the locking device is described below.

A control panel 40 may be installed on a front upper portion of the main body 10. The control panel 40 may be provided to operate electrical components provided within an electrical compartment 50.

The control panel 40 may include an input device 41. The input device 41 may be provided to allow the user to input commands for operations, such as a cooking function, a cooking mode, a cooking time, or the like of the cooking appliance. According to one example, the input device 41 may include a plurality of switches by which the user may select the cooking mode. The plurality of switches may be provided in a touch detection method.

The control panel 40 may include a display device 43. The display device 43 may be provided to display a condition set by the user and an operating state corresponding thereto using letters, numbers, and symbols.

The electrical compartment 50 may be formed within the main body 10. Electrical components for operating the cooking appliance may be installed within the electrical compartment 50. The electrical compartment 50 may be provided above the cooking chamber 20 as a space formed between the cooking chamber 20 and the main body 10.

The locking device may include the key member 33 provided on the door 30 and the latch device 100 provided on the main body 10 to lock the key member 33. The key member 33 may be positioned at an inner upper end of the door 30, and the latch device 100 may be positioned at a front upper end of the main body 10 to correspond to the position of the key member 33. The positions for installing the latch device 100 and the key member 33 may not be limited to those described above.

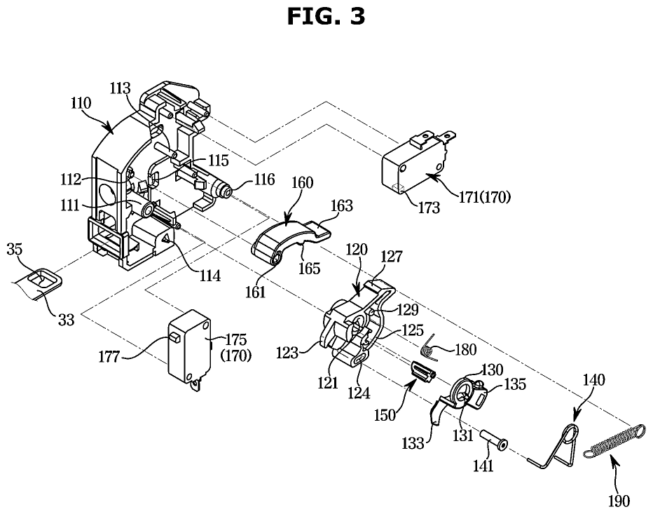

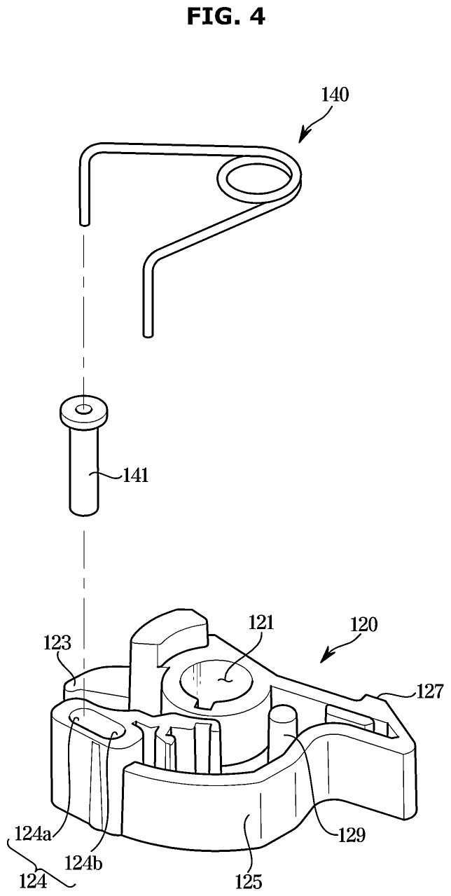

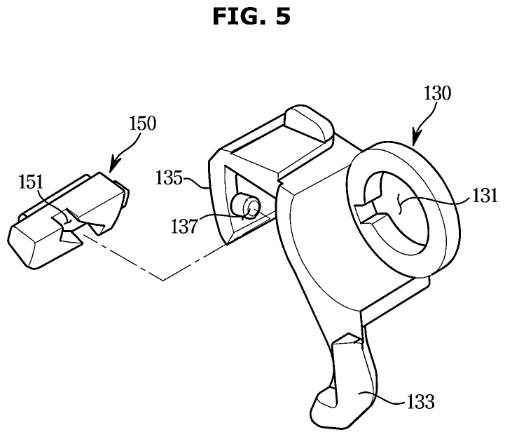

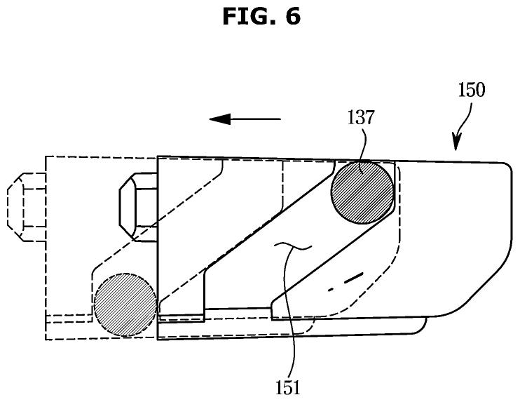

FIG. 3 is an exploded perspective view illustrating the key member and the latch device included in the locking device according to an embodiment of the disclosure. FIG. 4 is a view illustrating a state in which a spring is fixed to a first lever according to an embodiment of the disclosure. FIG. 5 is a view illustrating a state in which a stopper according to an embodiment of the disclosure is connected to a second lever. FIG. 6 is a view illustrating a state in which a guide protrusion of the second lever is inserted into a guide groove of the stopper and the stopper is moved according to the rotation of the second lever according to an embodiment of the disclosure.

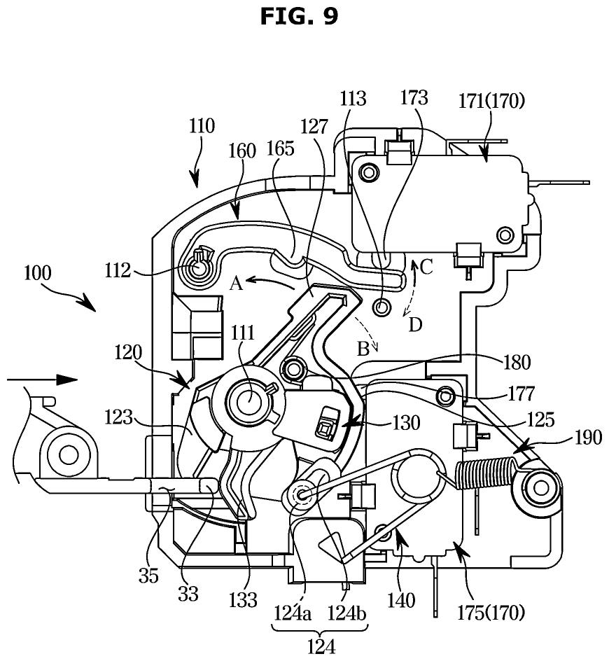

In the following, a direction of rotation may be described with reference to FIG. 9. In other words, a first direction may be A direction shown in FIG. 9, a second direction may be B direction shown in FIG. 9, a third direction may be C direction shown in FIG. 9, and a fourth direction may be D direction shown in FIG. 9.

As shown in FIGS. 3 to 6, the locking device may include the key member 33 provided on the door 30 and the latch device 100 provided on the main body 10 to lock the key member 33 (see FIG. 2).

The key member 33 may include a locking hole 35. In response to the door 30 (see FIG. 2) being closed, a hook portion 123 of a first lever 120 is inserted into the locking hole 35 of the key member 33, and thus the door 30 may be locked.

The latch device 100 may include a body 110 mounted on the main body 10 (see FIG. 2). The latch device 100 may include the first lever 120 and a second lever 130, which are rotatably mounted on the body 110. The latch device 100 may include a spring 140 having opposite ends attached to the first lever 120 and the body 110 to provide an elastic force to the first lever 120.

The body 110 may include a first rotation shaft 111 on which the first lever 120 and the second lever 130 are rotatably mounted. In response to opening or closing of the door 30 (see FIG. 2), the first lever 120 and the second lever 130 may rotate about the first rotation shaft 111. When the door 30 (see FIG. 2) is closed, the first lever 120 and the second lever 130 may be rotated in the first direction (direction A) about the first rotation shaft 111 by the key member 33. The first direction may be the same direction as an opening direction of the door 30. The first lever 120 and the second lever 130 may include shaft holes 121 and 131 rotatably inserted into the first rotation shaft 111, respectively.

The body 110 may include a second rotation shaft 112 on which a pressing member 160 is rotatably mounted. The pressing member 160 may be pressed by the first lever 120 to rotate about the second rotation shaft 112 as the first lever 120 rotates. When the first lever 120 rotates in the first direction and presses one side of the pressing member 160, the pressing member 160 may rotate about the second rotation shaft 112 in the third direction to press a first switch. The pressing member 160 may reliably press the first switch 173 at a position adjacent to a first sensor 171. The pressing member 160 may include a shaft hole 161 rotatably inserted into the second rotation shaft 112.

The body 110 may include a support rib 113 provided to support the pressing member 160. The pressing member 160 may be supported by the support rib 113, and when pressed by the first lever 120, may rotate in the third direction to be spaced from the support rib 113.

The body 110 may include a spring mounting portion 114 to which the spring 140 is mounted. One end of the spring 140 may be slidably attached to a spring holding portion 124 of the first lever 120. The other end of the spring 140 may be mounted to the spring mounting portion 114 of the body 110.

The body 110 may include an interference hole 115 into which a stopper 150 is inserted. When the stopper 150 is inserted into the interference hole 115, rotation of the first lever 120 may be restricted. When the stopper 150 is separated from the interference hole 115, the first lever 120 may be rotated.

The body 110 may include a second elastic member holding portion 116. One side of a second elastic member 190 may be connected to the spring 140 and the other side thereof may be fixed to the second elastic member holding portion 116.

The first lever 120 may include the shaft hole 121 rotatably inserted into the first rotation shaft 111 of the body 110. The first lever 120 may be rotated about the first rotation shaft 111 in response to opening and closing of the door 30.

The first lever 120 may include the hook portion 123. In response to the door 30 (see FIG. 2) being closed, the hook portion 123 may be inserted into the locking hole 35 of the key member 33 by rotating the first lever 120. When the hook portion 123 is inserted into the locking hole 35, the door 30 may be locked in the closed state.

The first lever 120 may include the spring holding portion 124 to which one end of the spring 140 is slidably attached. The spring holding portion 124 may be formed as a slot to allow one end of the spring 140 to be slidably moved. In response to the opening and closing of the door 30 (see FIG. 2), one end of the spring 140 may be slidably moved within the spring holding portion 124, and thus the position of one end of the spring 140 may be changed.

The first lever 120 may include a first pressing portion 125 that presses the pressing member 160. When the first lever 120 rotates, the first pressing portion 125 may press the pressing member 160 to allow the pressing member 160 to rotate around the second rotation shaft 112. The pressing member 160 may be rotated by the first pressing portion 125 to press the first switch 173 provided in the first sensor 171.

The first lever 120 may include a second pressing portion 127 that presses a second switch 177 provided in a second sensor 175. When the first lever 120 is rotated by closing the door 30 (see FIG. 2), the second pressing portion 127 may press the second switch 177.

The first lever 120 may include a first elastic member fastening portion 129 to which a first elastic member 180 is fastened. The first elastic member 180 may be provided between the first lever 120 and the second lever 130. The first elastic member 180 may provide elastic force in a direction in which a first side of the first lever 120 and a first side of the second lever 130 move away from each other. In the absence of an external force, the first side of the first lever 120 and the first side of the second lever 130 may remain spaced apart by the first elastic member 180.

The second lever 130 may include the shaft hole 131 rotatably inserted into the first rotation shaft 111 of the body 110. The second lever 130 may rotate around the first rotation shaft 111 in response to the opening and closing of the door 30 (see FIG. 2).

The second lever 130 may include a lever portion 133 that is pressed by the key member 33. When the lever portion 133 is pressed by the key member 33 by closing the door 30 (see FIG. 2), the second lever 130 may rotate about the first rotation shaft 111.

The second lever 130 may include a guide portion 135 provided to guide a movement of the stopper 150. The guide portion 135 may guide the movement of the stopper 150 to enable the stopper 150 to be inserted into or removed from the interference hole 115.

The second lever 130 may include a guide protrusion 137 provided to protrude from the guide portion 135. The guide protrusion 137 may be inserted into the guide groove 151 of the stopper 150. The guide protrusion 137 may move along the guide groove 151 to allow the stopper 150 to move left or right.

The spring 140 may be provided as a torsion spring. One end of the spring 140 may be fastened to the spring holding portion 124 of the first lever 120. The other end of the spring 140 may be fastened to the spring mounting portion 114 of the body 110. The other end of the spring 140 may be prevented from moving. The spring 140 may provide an elastic force to the first lever 120. One end of the spring 140 may be slidably attached to the spring holding portion 124 formed of the slot. A bush 141 may be provided at one end of the spring 140. The bush 141 may allow one end of the spring 140 to slide smoothly within the spring holding portion 124. Here, the bush 141 is provided at one end of the spring 140, but is not limited thereto. In other words, any structure other than the bush 141 may be used if one end of the spring 140 slides smoothly within the spring holding portion 124. One end of the spring 140 may be moved by sliding within the spring holding portion 124 in response to the opening and closing of the door 30.

The slot, which is the spring holding portion 124, may include a first position 124a where one end of the spring 140 is located when the door 30 is open, and a second position 124b where one end of the spring 140 is located when the door 30 is closed. The first position 124a may be one end of the slot. The second position 124b may be the other end of the slot opposite to the first position 124a. In more detail, prior to the latch device 100 being pressed by the key member 33, one end of the spring 140 may be positioned at the first position 124a of the slot. When the latch device 100 is pressed by the key member 33 to fully close the door 30 (see FIG. 2), one end of the spring 140 may be positioned at the second position 124b of the slot.

The spring 140 may provide an elastic force to allow the first lever 120 to rotate in the second direction. When the door 30 (see FIG. 2) is closed, the first lever 120 may be pressed by the second lever 130 and rotate in the first direction, while when the door 30 is open, the first lever 120 may rotate in the second direction by the elastic force of the spring 140 and return to its original state.

More specifically, the spring 140 may be installed to have the elastic force in a direction in which one end attached to the first lever 120 and the other end attached to the body 110 move away from each other. Accordingly, from the moment the door 30 (see FIG. 2) is closed until the first lever 120 rotates by a predetermined angle, the spring 140 may exert the elastic force to allow the first lever 120 to rotate in the second direction. In other words, when one end of the spring 140 is positioned at the first position 124a of the slot, the spring 140 may exert the elastic force to rotate the first lever 120 in the second direction. When the door 30 (see FIG. 2) is in an open state, one end of the spring 140 is positioned at the first position 124a of the slot, and thus the spring 140 may be widen at the maximum angle relative to the other end thereof. In other words, the spring 140 is open by a predetermined angle wider than when one end of the spring is positioned at the second position 124b of the slot, and thus the elastic force for rotating the first lever 120 in the second direction may be less. The less the elastic force for rotating the first lever 120 in the second direction may cause a user to close the door 30 (see FIG. 2) with a small force. As a result, the door 30 may be closed smoothly and the emotional quality may be improved accordingly.

Thereafter, when the door 30 (see FIG. 2) is completely closed, the spring 140 rotates around the other end attached to the body 110 as the first lever 120 rotates, and the position thereof may be changed. When the position of one end of the spring 140 is changed from the first position 124a to the second position 124b as a result of the spring 140 being rotated around the other end and the position being changed, the spring 140 may exert the elastic force in a direction in which one end moves away from the other. Accordingly, the spring may exert the elastic force to cause the first lever 120 to rotate in the first direction. When the door 30 (see FIG. 2) is in a closed state, one end of the spring 140 is positioned at the second position 124b of the slot, and thus the spring 140 may open at the largest angle relative to the other end thereof. In other words, the spring 140 is open by a predetermined angle wider than when one end of the spring is positioned at the first position 124a of the slot, and thus the elastic force for rotating the first lever 120 in the first direction may be less. The smaller the elastic force for rotating the first lever 120 in the first direction, the greater the force with which the door 30 (see FIG. 2) may be locked.

As described above, in response to the opening and closing of the door 30, one end of the spring 140 may be slid to change position. Accordingly, when the door 30 is closed, the door may be closed smoothly with a small force, and after the door 30 is closed, a large closing force may be generated (see FIG. 2).

The latch device 100 may include the stopper 150. The stopper 150 may be connected to the second lever 130. The stopper 150 may include the guide groove 151 into which the guide protrusion 137 of the second lever 130 is inserted. The stopper 150 may be connected to the second lever 130 by having the guide protrusion 137 inserted into the guide groove 151. The stopper 150 may be inserted into the interference hole 115 of the body 110 to restrict rotation of the first lever 120. When the second lever 130 rotates according to the opening and closing of the door 30 (see FIG. 2), the stopper 150 may be moved to the left or right and inserted into or separated from the interference hole 115. In other words, when the stopper 150 is inserted into the interference hole 115, the rotation of the first lever 120 may be restricted. Conversely, when the stopper 150 is separated from the interference hole 115, the first lever 120 may rotate.

In more detail, the guide groove 151 may extend in a front-rear direction and be inclined in a left-right direction. For example, the guide groove 151 may be provided to extend from the right front to the left rear.

In response to the second lever 130 being pressed or releasing from a pressed state, the guide protrusion 137 may move along the guide groove 151 and in turn the stopper 150 may move left or right. Accordingly, a direction of extension of the first rotation shaft 111 into which the second lever 130 is rotatably inserted and a direction of movement of the stopper 150 may be in substantially the same. In the absence of an external force, the stopper 150 may interfere with the first lever 120 to prevent the first lever 120 from rotating in the first direction.

For example, when the stopper 150 is inserted into the interference hole 115 provided in the body 110, the first lever 120 may be locked to restrict rotation in the first direction. When the second lever 130 is pressed, the stopper 150 may move to the right to exit from the interference hole 115. When the stopper 150 exits from the interference hole 115, the first lever 120 is unlocked, allowing the first lever 120 to rotate in the first direction together with the second lever 130.

As such, in a state in which the second lever 130 is not pressed, the stopper 150 may restrict the rotation of the first lever 120. In detail, when the lever portion 133 of the second lever 130 is not pressed, the first lever 120 is not rotated by the stopper 150 and the first switch 173 and the second switch 177 are not pressed, so that the door 30 (see FIG. 2) may not be detected as being closed. As a result, the cooking appliance may not operate.

The lever portion 133 of the second lever 130 is provided in a shape protruding from the body of the second lever 130, and when an object other than the key member 33, which has a transverse length greater than a predetermined length, is inserted into the latch device 100, it may be difficult to accurately press the lever portion 133. Accordingly, even if the object other than the key member 33 is inserted into the latch device 100, it may be difficult to release a locking state of the stopper 150. Consequently, the rotation of the first lever 120 in the first direction may be restricted by the stopper 150, and the first switch 173 and the second sensor 171 and the second sensor 175 provided on the first sensor 171 and the second sensor 175 may also not be pressed. That is, even if the object other than the key member 33 is inserted into the latch device 100, the rotation of the second lever 130 is not allowed, and thus the stopper 150 may maintain a state in which the rotation of the first lever 130 is restricted. As a result, the cooking appliance may be prevented from malfunctioning while the door 30 (see FIG. 2) is open.

The latch device 100 may include the pressing member 160. The pressing member 160 may be disposed above the first lever 120. The pressing member 160 may include the shaft hole 161 rotatably inserted into the second rotation shaft 112 of the body 110. In response to the first lever 120 being rotated, the pressing member 160 may be pressed by the first pressing portion 125 to rotate about the second rotation shaft 112.

The pressing member 160 may include a switch pressing portion 163 that presses the first switch 173. The pressing member 160 is rotated about the second rotation shaft 112 by the first lever 120 to allow the switch pressing portion 163 to press the first switch 173.

The pressing member 160 may include a pressing protrusion 165. The pressing protrusion 165 may be pressed by the first pressing portion 125 when the first lever 120 is rotated. As the pressing protrusion 165 is pressed by the first pressing portion 125, the pressing member 160 may be rotated about the second rotation shaft 112.

The latch device 100 may include a sensor 170 that detects whether the door 30 is closed. The sensor 170 may be mounted on the body 100. The cooking appliance may only be operated when the sensor 170 detects that the door 30 is normally closed. In other words, unless the sensor detects that the door 30 is normally closed, the cooking appliance is not operated, thereby preventing a malfunction (see FIG. 2).

More specifically, in response to the key member 33 pressing the latch device 100 by the closing of the door 30, the switches 173 and 177 provided in the sensor 170 may be pressed by the latch device 100, so that the door 30 may be detected as normally closed (see FIG. 2).

The sensor 170 may include the first sensor 171 and the second sensor 175. The first sensor 171 and the second sensor 175 may be provided with the first switch 173 and the second switch 177 pressed by the first lever 120, respectively.

The first sensor 171 may be located above the first lever 120. The second sensor 175 may be located behind the first lever 120. The first switch 173 may be pressed by the switch pressing portion 163 of the pressing member 160 that is pressed by the first pressing portion 125 of the first lever 120 and rotated. The second switch 177 may be pressed by the second pressing portion 127 of the first lever 120.

That is, in response to the closing of the door 30, the first lever 120 may rotate in the first direction to press the first switch 173 and the second switch 177. The first sensor 171 or the second sensor 175 may not be mounted on the body 110 and may be located outside the body 110 so as to be pressed by the first lever 120.

The latch device 100 may include the first elastic member 180 provided between the first lever 120 and the second lever 130. The first elastic member 180 may be attached to the first elastic member fastening portion 129 of the first lever 120. The first elastic member 180 may provide an elastic force in a direction in which one side of the first lever 120 and one side of the second lever 130 move away from each other. In the absence of an external force, one side of the first lever 120 and one side of the second lever 130 may remain spaced apart by the first elastic member 180. The first elastic member 180 may exert an elastic force to cause the second lever 130 to rotate in the second direction opposite to the first direction relative to the first lever 120.

The latch device 100 may include the second elastic member 190 providing elastic force to the spring 140. One side of the second elastic member 190 may be held to the second elastic member holding portion 116 of the body 110. The other side of the second elastic member 190 may be connected to the spring 140 to provide an elastic force to the spring 140. The second elastic member 190 may have an elastic force in a direction in which the key member 33 is inserted into the latch device 100. The second elastic member 190 may provide an elastic force to the spring 140, and thus the first lever 120 may be rotated in the first direction with a relatively small force.

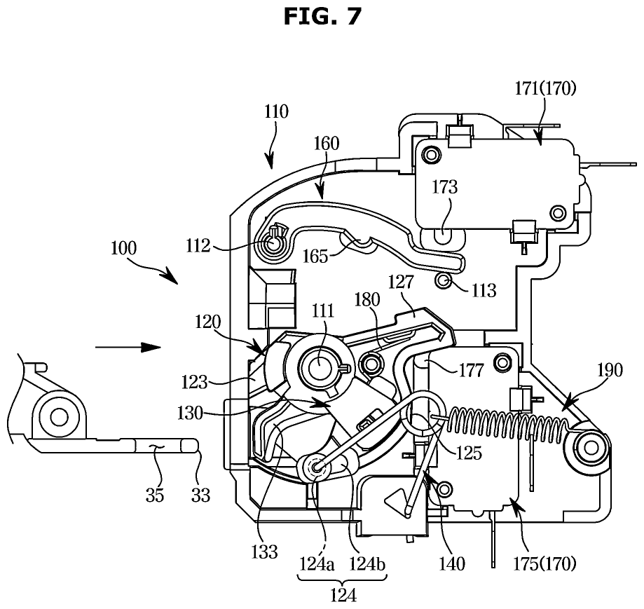

Next, an operation of the latch device 100 in response to the closing of the door 30 will be described in detail with reference to FIGS. 7 to 10.

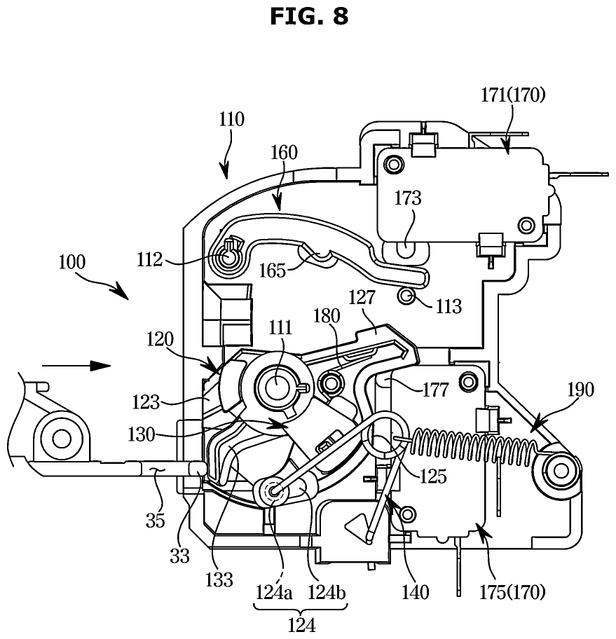

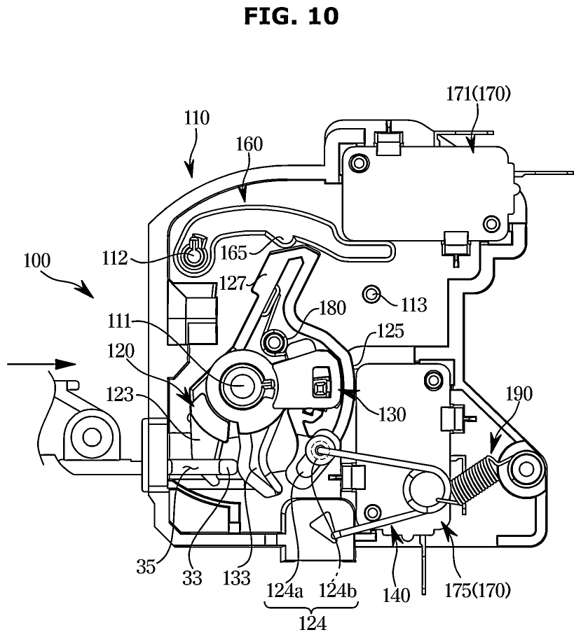

FIG. 7 is a view illustrating a state prior to the latch device being pressed by the key member according to an embodiment of the disclosure. FIG. 8 is a view illustrating a state in which the key member contacts the latch device according to an embodiment of the disclosure. FIG. 9 is a view illustrating a state in which the first lever and the second lever are rotated in the first direction when the latch device is pressed by the key member according to an embodiment of the disclosure. FIG. 10 is a view illustrating a state in which the hook portion of the latch device is inserted and locked into a locking hole of the key member according to an embodiment of the disclosure.

As shown in FIG. 7, before the key member 33 presses the latch device 100 in a closing operation of the door 30 (see FIG. 2), the spring 140 may provide an elastic force to rotate the first lever 120 in the second direction that is opposite to the first direction. The first direction may be the same direction as a direction of the opening of the door 30 (see FIG. 2). The second direction may be the same direction as a direction of the closing of the door 30 (see FIG. 2).

As shown in FIG. 8, in response to the further progress of the closing operation of the door 30 (see FIG. 2), the key member 33 may come into contact with the lever portion 133 of the second lever 130. At this time, the spring 140 may still provide an elastic force to rotate the first lever 120 in the second direction opposite to the first direction. At this time, because one end of the spring 140 is located at the first position 124a of the slot 124, an elastic force for rotating the lever 120 in the second direction may be reduced compared to when the one end of the spring 140 is located at the second position 124b of the slot 124. Accordingly, the user may close the door 30 (see FIG. 2) with less force.

As shown in FIG. 9, in response to the lever portion 133 of the second lever 130 being pressed by the key member 33, the second lever 130 may be rotated in the first direction. The stopper 150 may be in a locked state to interfere with the first lever 120, and then be released from the locked state as the second lever 130 rotates. In response to the release from the locked state by the stopper 150, the first lever 120 may be rotated in the first direction together with the second lever 130.

In response to the first lever 120 being rotated in the first direction together with the second lever 130, the first pressing portion 125 of the first lever 120 may be in contact with the pressing member 160 so as to rotate the pressing member 160 in the third direction (C direction).

As shown in FIG. 10, when the door 30 (see FIG. 2) is completely closed, the first pressing portion 125 of the first lever 120 may press the pressing protrusion 165 of the pressing member 160. In response to the pressing protrusion 165 of the pressing member 160 being pressed, the pressing member 160 may be rotated in the third direction around the second rotation shaft 112, and thus the switch pressing portion 163 may press the first switch 173.

At this time, when the first pressing portion 125 of the first lever 120 passes the pressing protrusion 165 by rotating by an angle greater than a normal angle, the pressing member 160 may rotate in the fourth direction again. Accordingly, the switch pressing portion 163 of the pressing member 160 may be spaced apart from the first sensor 171. According to such a configuration, the first switch 173 of the first sensor 171 of the disclosure may be prevented from being excessively pressed by the switch pressing portion 163 of the pressing member 160.

In response to the release from a pressing state of the pressing member 160, the pressing member 160 may rotate in the fourth direction (direction D) opposite to the third direction and return to its original position. In other words, the pressing member 160 is supported by the support rib 113, and when pressed by the first lever 42, the pressing member 160 may rotate in the third direction and be spaced apart from the support rib 113. In addition, when the pressing member 160 is rotated in the fourth direction after the pressing state is released, the pressing member 160 may be supported by the support rib 113 again.

In response to the first lever 120 being rotated in the first direction together with the second lever 130, the second pressing portion 127 of the first lever 120 may press the second switch 177 of the second sensor 175.

The spring 140 may be rotated around the other end held to the spring mounting portion 114 of the body 110 by the first lever 120 rotating in the first direction. In a state in which the spring 140 is rotated about the other end, the spring 140 may provide an elastic force to rotate the first lever 120 in the first direction.

As the spring 140 rotates around the other end, one end of the spring 140 may slide from the first position 124a to the second position 124b of the slot 124. At this time, when one end of the spring 140 is located at the second position 124b of the slot 124, an elastic force for rotating the lever 120 in the first direction may be reduced compared to when the first end of the spring 140 is located at the first position 124a of the slot 124. Accordingly, the door 30 (see FIG. 2) may be locked with a greater force.

At this time, the hook portion 123 of the first lever 120 is inserted into the locking hole 35 of the key member 33, so that the door 30 may be completely locked to the main body 10.

While the present disclosure has been particularly described with reference to exemplary embodiments, it should be understood by those of skilled in the art that various changes in form and details may be made without departing from the spirit and scope of the present disclosure.

1. A cooking appliance, comprising:
a door;
a key member on the door;
a main body; and
a latch device on the main body and which becomes locked with the key member when the door is being closed, the latch device including:
a body,
a first lever rotatably coupled to the body,
a second lever that, when the door is being closed, is pressed by the key member to thereby cause the second lever to rotate in a first direction so as to press the first lever and thereby cause the first lever to rotate in the first direction,
a spring holding portion on the first lever, and
a spring having
a first end attached to the first lever and slidably held by the spring holding portion so as to be at a first position in the spring holding portion when the door is open and at a second position in the spring holding portion when the door is closed, and
a second end attached to the body,
wherein the spring provides an elastic force to cause the first lever to rotate in a second direction opposite to the first direction when the door is being opened.

2. The cooking appliance of claim 1, wherein the spring holding portion is a slot.

3. The cooking appliance of claim 2, wherein the spring is a torsion spring, and the second end of the spring is held to the body so as to prevent movement of the second end of the spring.

4. The cooking appliance of claim 3, wherein the first end of the spring is provided with a bush slidably inserted into the slot to allow the first end of the spring to slide along the slot.

5. The cooking appliance of claim 4, wherein the spring provides an elastic force to cause the first lever to rotate in the first direction in response to the second lever being pressed by the key member when the door is being closed.

6. The cooking appliance of claim 5, wherein the first position corresponds to a first end of the slot that is widened to allow the first end of the spring to be at a maximum angle relative to the second end of the spring when the door is open.

7. The cooking appliance of claim 5, wherein the second position corresponds to a second end of the slot that is widened to allow the first end of the spring to be at a maximum angle relative to the second end of the spring when the door is closed.

8. The cooking appliance of claim 1, wherein the spring is positioned at the first position to allow an elastic force for rotating the first lever in the second direction when the door is being opened to be small, so that the door may be closed with a small force.

9. The cooking appliance of claim 1, wherein the spring is positioned at the second position to allow an elastic force for rotating the first lever in the first direction when the door is being closed to be small, so that a force for locking the door may increase.

10. The cooking appliance of claim 1, wherein the latch device further includes a stopper connected to the second lever and restricting rotation of the first lever, and a sensor selectively pressed by the first lever for detecting whether the door is open or closed.

11. The cooking appliance of claim 10, wherein the body includes an interference hole into which the stopper is inserted to restrict the rotation of the first lever, and the stopper is separated from the interference hole in response to the second lever rotating in the first direction, so that the first lever rotates in the first direction together with the second lever.

12. The cooking appliance of claim 1, wherein the latch device further includes a first elastic member having a first end connected to the first lever and a second end connected to the second lever, and the first elastic member exerts an elastic force that causes the second lever to rotate in the second direction relative to the first lever.

13. The cooking appliance of claim 10, wherein the latch device further includes a pressing member rotatably provided on the body to be pressed by the first lever in response to the first lever rotating in the first direction, and the pressing member is rotated to press a switch provided in the sensor when pressed by the first lever.

14. The cooking appliance of claim 1, wherein the latch device further includes an elastic member having a first end connected to the spring and a second end attached to the body, and the elastic member exerts an elastic force to the spring in a direction in which the key member is inserted into the latch device.
